(19) United States
(12) Patent Application Publication
(10) Pub. No.: US 2006/0159173 A1
(43) Pub. Date: Jul. 20, 2006

(54) Video coding in an overcomplete wavelet domain

(75) Inventors: Jong Chul Ye, Yuseong-Gu (KR); Mihaela Van Der Schaar, Martinez, CA (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/562,533

(22) PCT Filed: Jun. 28, 2004
(86) PCT No.: PCT/IB04/51036

§ 371 Date: Dec. 28, 2005

(30) Foreign Application Priority Data
Jun. 30, 2003 (US) 60483793

(51) Int. Cl. H04N 11/02; H04B 1/66; H04N 11/04; H04N 7/12

(52) U.S. Cl. 375/240.16; 375/240.08; 375/240.2; 375/240.19

(57) ABSTRACT

Encoding and decoding methods and apparatuses are provided for encoding and decoding video frames. The encoding method (600) and apparatus (110) use motion compensated discrete cosine transform coding for the base layer and inband motion compensated temporal filtering in the overcomplete wavelet domain for the enhancement layer. The decoding method (700) and apparatus (118) use motion compensated discrete cosine transform decoding for the base layer and inverse motion compensated temporal filtering in the overcomplete wavelet domain for the enhancement layer.

This disclosure relates generally to video coding systems and more specifically to video coding in an overcomplete wavelet domain.

Real-time streaming of multimedia content over data networks has become an increasingly common application in recent years. For example, multimedia applications such as news-on-demand, live network television viewing, and video conferencing often rely on end-to-end streaming of video information. Streaming video applications typically include a video transmitter that encodes and transmits a video signal over a network to a video receiver that decodes and displays the video signal in real time.

Scalable video coding is typically a desirable feature for many multimedia applications and services. Scalability allows processors with lower computational power to decode only a subset of a video stream, while processors with higher computational power can decode the entire video stream. Another use of scalability is in environments with a variable transmission bandwidth. In those environments, receivers with lower-access bandwidth receive and decode only a subset of the video stream, while receivers with higher-access bandwidth receive and decode the entire video stream.

Several video scalability approaches have been adopted by lead video compression standards such as MPEG-2 and MPEG-4. Temporal, spatial, and quality (e.g., signal-noise ratio or “SNR”) scalability types have been defined in these standards. These approaches typically include a base layer (BL) and an enhancement layer (EL). The base layer of a video stream represents, in general, the minimum amount of data needed for decoding that stream. The enhancement layer of the stream represents additional information, which enhances the video signal representation when decoded by the receiver.

Many current video coding systems use motion-compensated predictive coding for the base layer and discrete cosine transform (DCT) residual coding for the enhancement layer. This is typically referred to as “motion compensated” DCT coding (MC-DCT). In these systems, temporal redundancy is reduced using motion compensation, and spatial resolution is reduced by transform coding the residue of the motion compensation. However, these systems are typically prone to problems such as error propagation (or drift) and a lack of true scalability.

This disclosure provides an improved coding system that uses motion prediction in an overcomplete wavelet domain. In one aspect, a hybrid three-dimensional (3D) wavelet video coder uses motion compensated DCT (MC-DCT) coding for the base layer and 3D inband motion compensated temporal filtering (MCTF) or unconstrained MCTF (UMCTF) in the overcomplete wavelet domain for the enhancement layer.

For a more complete understanding of the this disclosure, reference is now made to the following descriptions taken in conjunction with the accompanying drawings, in which:

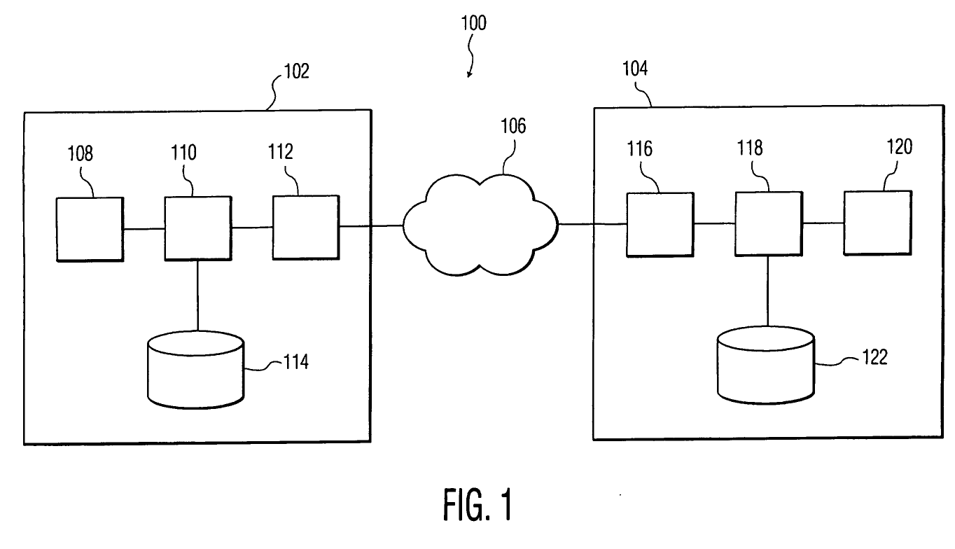

FIG. 1 illustrates an example video transmission system according to one embodiment of this disclosure;

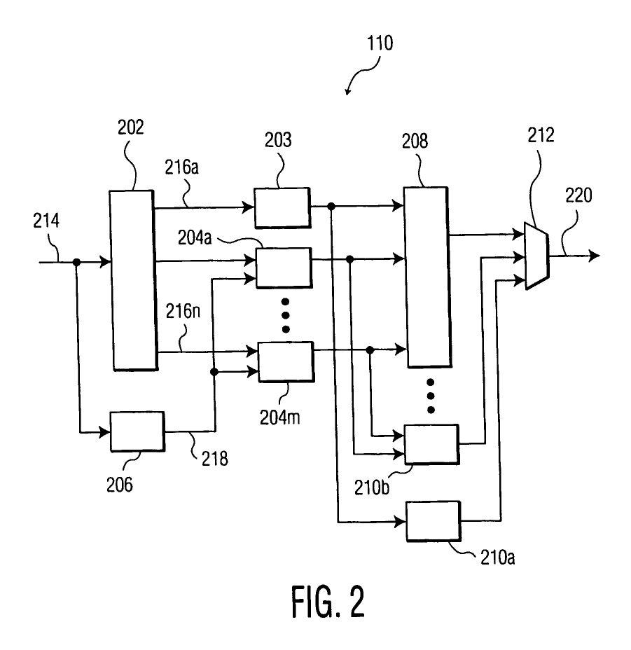

FIG. 2 illustrates an example video encoder according to one embodiment of this disclosure;

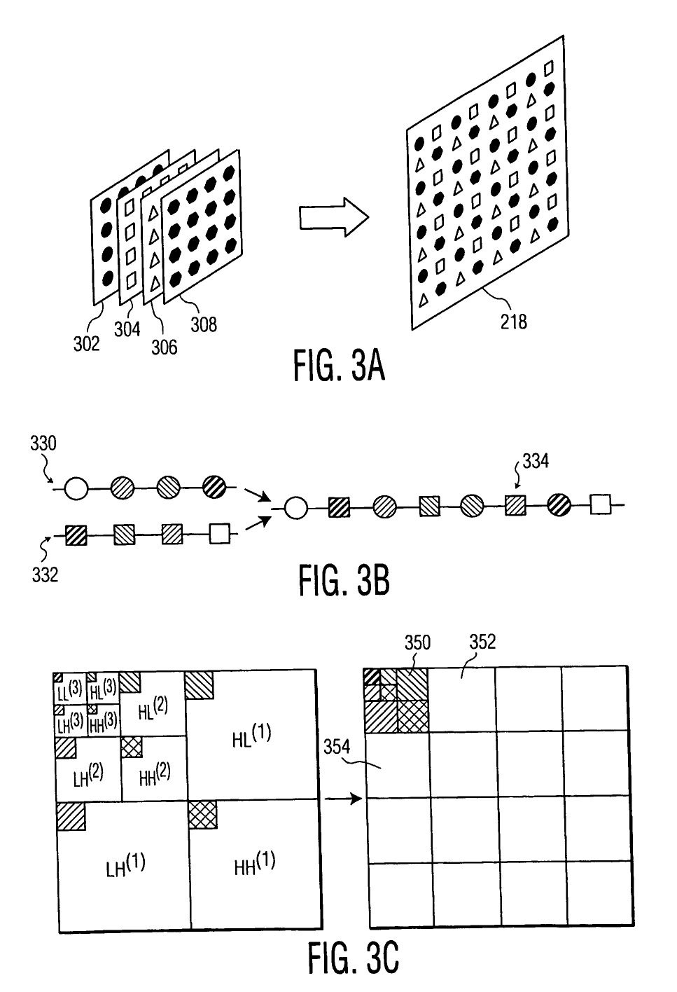

FIG. 3 illustrates an example reference frame generated by overcomplete wavelet expansion according to one embodiment of this disclosure;

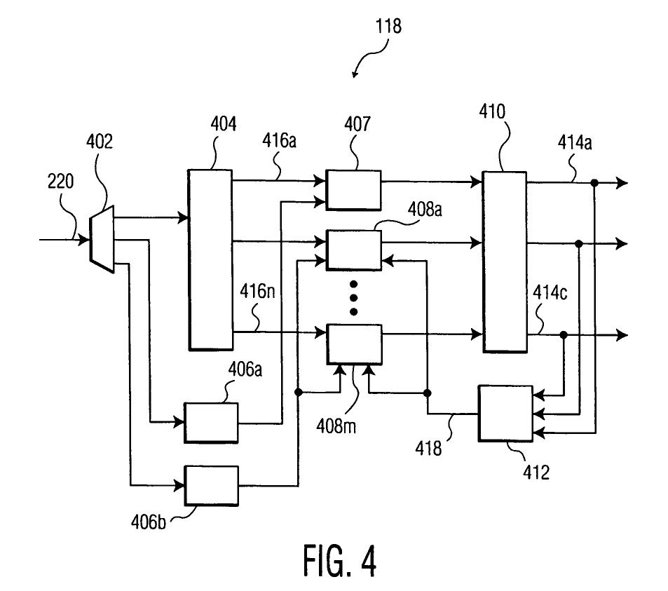

FIG. 4 illustrates an example video decoder according to one embodiment of this disclosure;

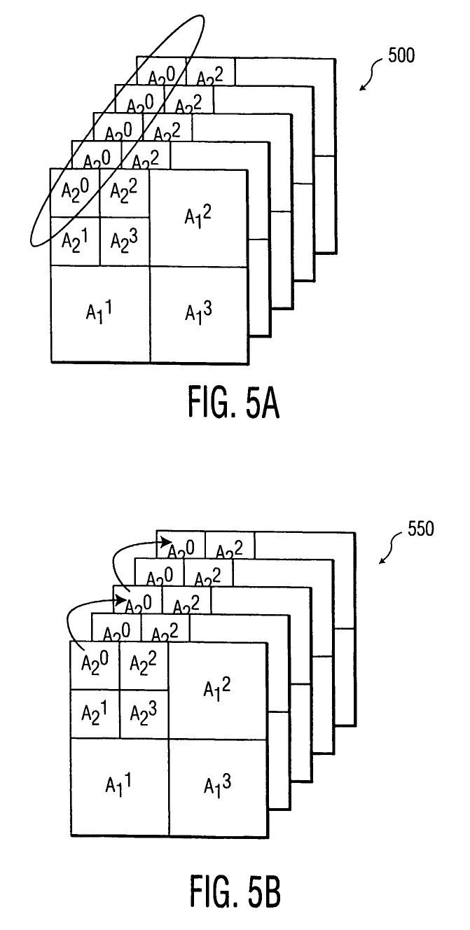

FIGS. 5A and 5B illustrate example encodings of video information according to one embodiment of this disclosure;

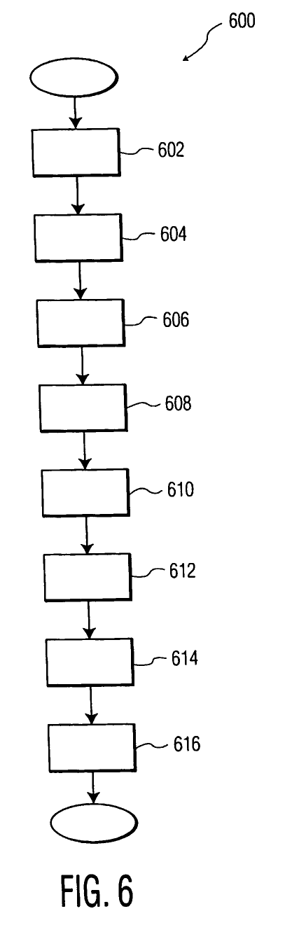

FIG. 6 illustrates an example method for encoding video information in an overcomplete wavelet domain according to one embodiment of this disclosure; and

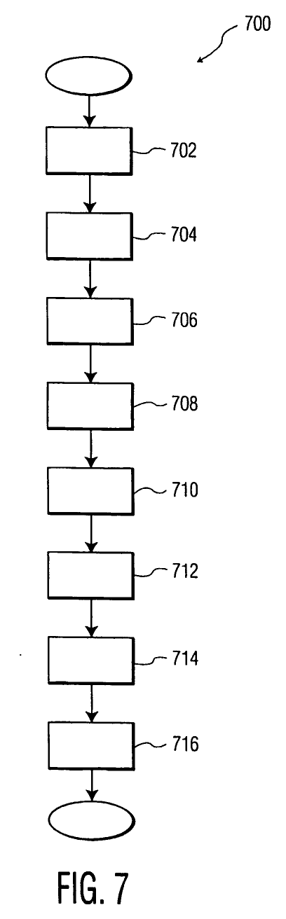

FIG. 7 illustrates an example method for decoding video information in an overcomplete wavelet domain according to one embodiment of this disclosure.

FIGS. 1 through 7, discussed below, and the various embodiments described in this patent document are by way of illustration only and should not be construed in any way to limit the scope of the invention. Those skilled in the art will understand that the principles of the invention may be implemented in any suitably arranged video encoder, video decoder, or other apparatus, device, or structure.

FIG. 1 illustrates an example video transmission system 100 according to one embodiment of this disclosure. In the illustrated embodiment, the system 100 includes a streaming video transmitter 102, a streaming video receiver 104, and a data network 106. Other embodiments of the video transmission system may be used without departing from the scope of this disclosure.

The streaming video transmitter 102 streams video information to the streaming video receiver 104 over the network 106. The streaming video transmitter 102 may also stream audio or other information to the streaming video receiver 104. The streaming video transmitter 102 includes any of a wide variety of sources of video frames, including a data network server, a television station transmitter, a cable network, or a desktop personal computer.

In the illustrated example, the streaming video transmitter 102 includes a video frame source 108, a video encoder 110, an encoder buffer 112, and a memory 114. The video frame source 108 represents any device or structure capable of generating or otherwise providing a sequence of uncompressed video frames, such as a television antenna and receiver unit, a video cassette player, a video camera, or a disk storage device capable of storing a “raw” video clip.

The uncompressed video frames enter the video encoder 110 at a given picture rate (or “streaming rate”) and are compressed by the video encoder 110. The video encoder 110 then transmits the compressed video frames to the encoder buffer 112. The video encoder 110 represents any suitable encoder for coding video frames. In some embodiments, the video encoder 110 represents a hybrid 3D wavelet video encoder that uses MC-DCT coding for the base layer and 3D inband MCTF or UMCTF in the overcomplete wavelet domain for the enhancement layer. One example of the video encoder 110 is shown in FIG. 2, which is described below.

The encoder buffer 112 receives the compressed video frames from the video encoder 110 and buffers the video frames in preparation for transmission across the data network 106. The encoder buffer 112 represents any suitable buffer for storing compressed video frames.

The streaming video receiver 104 receives the compressed video frames streamed over the data network 106 by the streaming video transmitter 102. In the illustrated example, the streaming video receiver 104 includes a decoder buffer 116, a video decoder 118, a video display 120, and a memory 122. Depending on the application, the streaming video receiver 104 may represent any of a wide variety of video frame receivers, including a television receiver, a desktop personal computer, or a video cassette recorder. The decoder buffer 116 stores compressed video frames received over the data network 106. The decoder buffer 116 then transmits the compressed video frames to the video decoder 118 as required. The decoder buffer 116 represents any suitable buffer for storing compressed video frames.

The video decoder 118 decompresses the video frames that were compressed by the video encoder 110. The compressed video frames are scalable, allowing the video decoder 118 to decode part or all of the compressed video frames. The video decoder 118 then sends the decompressed frames to the video display 120 for presentation. The video decoder 118 represents any suitable decoder for decoding video frames. In some embodiments, the video decoder 118 represents a hybrid 3D wavelet video decoder that uses MC-DCT decoding for the base layer and inverse 3D inband MCTF or UMCTF in the overcomplete wavelet domain for the enhancement layer. One example of the video decoder 118 is shown in FIG. 4, which is described below. The video display 120 represents any suitable device or structure for presenting video frames to a user, such as a television, PC screen, or projector.

In some embodiments, the video encoder 110 is implemented as a software program executed by a conventional data processor, such as a standard MPEG encoder. In these embodiments, the video encoder 110 includes a plurality of computer executable instructions, such as instructions stored in the memory 114. Similarly, in some embodiments, the video decoder 118 is implemented as a software program executed by a conventional data processor, such as a standard MPEG decoder. In these embodiments, the video decoder 118 includes a plurality of computer executable instructions, such as instructions stored in the memory 122. The memories 114, 122 each represents any volatile or non-volatile storage and retrieval device or devices, such as a fixed magnetic disk, a removable magnetic disk, a CD, a DVD, magnetic tape, or a video disk. In other embodiments, the video encoder 110 and video decoder 118 are each implemented in hardware, software, firmware, or any combination thereof.

The data network 106 facilitates communication between components of the system 100. For example, the network 106 may communicate Internet Protocol (IP) packets, frame relay frames, Asynchronous Transfer Mode (ATM) cells, or other suitable information between network addresses or components. The network 106 may include one or more local area networks (LANs), metropolitan area networks (MANs), wide area networks (WANs), all or a portion of a global network such as the Internet, or any other communication system or systems at one or more locations. The network 106 may also operate according to any appropriate type of protocol or protocols, such as Ethernet, IP, X.25, frame relay, or any other packet data protocol.

Although FIG. 1 illustrates one example of a video transmission system 100, various changes may be made to FIG. 1. For example, the system 100 may include any number of streaming video transmitters 102, streaming video receivers 104, and networks 106.

FIG. 2 illustrates an example video encoder 110 according to one embodiment of this disclosure. The video encoder 110 shown in FIG. 2 may be used in the video transmission system 100 shown in FIG. 1. Other embodiments of the video encoder 110 could be used in the video transmission system 100, and the video encoder 110 shown in FIG. 2 could be used in any other suitable device, structure, or system without departing from the scope of this disclosure.

In the illustrated example, the video encoder 110 includes a wavelet transformer 202. The wavelet transformer 202 receives uncompressed video frames 214 and transforms the video frames 214 from a spatial domain to a wavelet domain. This transformation spatially decomposes a video frame 214 into multiple bands 216a-216n using wavelet filtering, and each band 216 for that video frame 214 is represented by a set of wavelet coefficients. The wavelet transformer 202 uses any suitable transform to decompose a video frame 214 into multiple video or wavelet bands 216. In some embodiments, a frame 214 is decomposed into a first decomposition level that includes a low-low (LL) band, a low-high (LH) band, a high-low (HL) band, and a high-high (HH) band. One or more of these bands may be further decomposed into additional decomposition levels, such as when the LL band is further decomposed into LLLL, LLLH, LLHL, and LLHH sub-bands.

The wavelet bands 216 are provided to a motion compensated DCT (MC-DCT) coder 203 and a plurality of motion compensated temporal filters (MCTFs) 204a-204m. The MC-DCT coder 203 encodes the lowest resolution wavelet band 216a. The MCTFs 204 temporally filter the remaining video bands 216b-216n and remove temporal correlation between the frames 214. For example, the MCTFs 204 may filter the video bands 216 and generate high-pass frames and low-pass frames for each of the video bands 216. In this embodiment, the base layer of the video stream being compressed represents the lowest resolution wavelet band 216a processed by the MC-DCT coder 203, and the enhancement layer of the video stream represents the remaining wavelet bands 216b-216n processed by the MCTFs 204. The components of the video encoder 110 that process the base layer may referred to as “base layer circuitry,” while components that process the enhancement layer may be referred to as “enhancement layer circuitry.” Some components may process both layers and may form part of each layer's circuitry.

In some embodiments, groups of frames are processed by the MC-DCT coder 203 and the MCTFs 204. In particular embodiments, each MCTF 204 includes a motion estimator and a temporal filter. The MC-DCT coder 203 and the motion estimators in the MCTFs 204 generate one or more motion vectors, which estimate the amount of motion between a current video frame and a reference frame and produces one or more motion vectors. The temporal filters in the MCTFs 204 use this information to temporally filter a group of video frames in the motion direction. In other embodiments, the MCTFs 204 could be replaced by unconstrained motion compensated temporal filters (UMCTFs).

In some embodiments, interpolation filters in the motion estimators can have different coefficient values. Because different bands 216 may have different temporal correlations, this may help to improve the coding performance of the MCTFs 204. Also, different temporal filters may be used in the MCTFs 204. In some embodiments, bi-directional temporal filters are used for the lower bands 216 and forward-only temporal filters are used for the higher bands 216. The temporal filters can be selected based on a desire to minimize a distortion measure or a complexity measure. The temporal filters could represent any suitable filters, such as lifting filters that use prediction and update steps designed differently for each band 216 to increase or optimize the efficiency/complexity constraint.

In addition, the number of frames grouped together and processed by the MC-DCT coder 203 and the MCTFs 204 can be adaptively determined for each band 216. In some embodiments, lower bands 216 have a larger number of frames grouped together, and higher bands have a smaller number of frames grouped together. This allows, for example, the number of frames grouped together per band 216 to be varied based on the characteristics of the sequence of frames 214 or complexity or resiliency requirements. Also, higher spatial frequency bands 216 can be omitted from longer-term temporal filtering. As a particular example, frames in the LL, LH and HL, and HH bands 216 can be placed in groups of eight, four, and two frames, respectively. This allows a maximum decomposition level of three, two, and one, respectively. The number of temporal decomposition levels for each of the bands 216 can be determined using any suitable criteria, such as frame content, a target distortion metric, or a desired level of temporal scalability for each band 216. As another particular example, frames in each of the LL, LH and HL, and HH bands 216 may be placed in groups of eight frames.

As shown in FIG. 2, the MCTFs 204 operate in the wavelet domain. In conventional encoders, motion estimation and compensation in the wavelet domain is typically inefficient because the wavelet coefficients are not shift-invariant. This inefficiency may be overcome using a low band shifting technique. In the illustrated embodiment, a low band shifter 206 processes the input video frames 214 and generates one or more overcomplete wavelet expansions 218. The MCTFs 204 use the overcomplete wavelet expansions 218 as reference frames during motion estimation. The use of the overcomplete wavelet expansions 218 as the reference frames allows the MCTFs 204 to estimate motion to varying levels of accuracy. As a particular example, the MCTFs 204 could employ a 1/16 pel accuracy for motion estimation in the LL band 216 and a ⅛ pel accuracy for motion estimation in the other bands 216.

In some embodiments, the low band shifter 206 generates an overcomplete wavelet expansion 218 by shifting the lower bands of the input video frames 214. The generation of the overcomplete wavelet expansion 218 by the low band shifter 206 is shown in FIGS. 3A-3C. In this example, different shifted wavelet coefficients corresponding to the same decomposition level at a specific spatial location is referred to as “cross-phase wavelet coefficients.” As shown in FIG. 3A, an overcomplete wavelet expansion 218 is generated by shifting the wavelet coefficients of the next-finer level LL band. For example, wavelet coefficients 302 represent the coefficients of the LL band without shift. Wavelet coefficients 304 represent the coefficients of the LL band after a (1,0) shift, or a shift of one position to the right. Wavelet coefficients 306 represent the coefficients of the LL band after a (0,1) shift, or a shift of one position down. Wavelet coefficients 308 represent the coefficients of the LL band after a (1,1) shift, or a shift of one position to the right and one position down.

The four sets of wavelet coefficients 302-308 in FIG. 3A are augmented or combined to generate the overcomplete wavelet expansion 218. FIG. 3B illustrates one example of how the wavelet coefficients 302-308 may be augmented or combined to produce the overcomplete wavelet expansion 218. As shown in FIG. 3B, two sets of wavelet coefficients 330, 332 are interleaved to produce a set of overcomplete wavelet coefficients 334. The overcomplete wavelet coefficients 334 represent the overcomplete wavelet expansion 218 shown in FIG. 3A. The interleaving is performed such that the new coordinates in the overcomplete wavelet expansion 218 correspond to the associated shift in the original spatial domain. This interleaving technique can also be used recursively at each decomposition level and can be directly extended for 2D signals. The use of interleaving to generate the overcomplete wavelet coefficients 334 may enable more optimal or optimal sub-pixel accuracy motion estimation and compensation in the video encoder 110 and video decoder 118 because it allows consideration of cross-phase dependencies between neighboring wavelet coefficients. Although FIG. 3B illustrates two sets of wavelet coefficients 330, 332 being interleaved, any number of coefficient sets could be interleaved together to form the overcomplete wavelet coefficients 334, such as four sets of wavelet coefficients.

Part of the low band shifting technique involves the generation of wavelet blocks as shown in FIG. 3C. In some embodiments, during wavelet decomposition, coefficients at a given scale (except for coefficients in the highest frequency band) can be related to a set of coefficients of the same orientation at finer scales. In conventional coders, this relationship is exploited by representing the coefficients as a data structure called a “wavelet tree.” In the low band shifting technique, the coefficients of each wavelet tree rooted in the lowest band are rearranged to form a wavelet block 350 as shown in FIG. 3C. Other coefficients are similarly grouped to form additional wavelet blocks 352, 354. The wavelet blocks shown in FIG. 3C provide a direct association between the wavelet coefficients in that wavelet block and what those coefficients represent spatially in an image. In particular embodiments, related coefficients at all scales and orientations are included in each of the wavelet blocks.

In some embodiments, the wavelet blocks shown in FIG. 3C are used during motion estimation by the MCTFs 204. For example, during motion estimation, each MCTF 204 finds the motion vector (dₓ, d_{y}) that generates a minimum mean absolute difference (MAD) between the current wavelet block and a reference wavelet block in the reference frame. For example, the mean absolute difference of the k-th wavelet block in FIG. 3C could be computed as follows:

Returning to FIG. 2, the MC-DCT coder 203 and the MCTFs 204 provide filtered video bands to an Embedded Zero Block Coding (EZBC) coder 208. The EZBC coder 208 analyzes the filtered video bands and identifies correlations within the filtered bands 216 and between the filtered bands 216. The EZBC coder 208 uses this information to encode and compress the filtered bands 216. As a particular example, the EZBC coder 208 could compress the high-pass frames and low-pass frames generated by the MCTFs 204.

The MC-DCT coder 203 and the MCTFs 204 also provide motion vectors to two motion vector encoders 210a-210b. The motion vectors represent motion detected in the sequence of video frames 214 provided to the video encoder 110. The motion vector encoder 210a encodes the motion vectors generated by the MC-DCT coder 203, and the motion vector encoder 210b encodes the motion vectors generated by the MCTFs 204. The motion vector encoders 210 may represent any suitable coder that uses any suitable encoding technique, such as a texture or entropy based coding technique like MC-DCT coding.

Taken together, the compressed and filtered bands 216 produced by the EZBC coder 208 and the compressed motion vectors produced by the motion vector encoders 210 represent the input video frames 214. A multiplexer 212 receives the compressed and filtered bands 216 and the compressed motion vectors and multiplexes them onto a single output bitstream 220. The bitstream 220 is then transmitted by the streaming video transmitter 102 across the data network 106 to a streaming video receiver 104.

FIG. 4 illustrates one example of a video decoder 118 according to one embodiment of this disclosure. The video decoder 118 shown in FIG. 4 may be used in the video transmission system 100 shown in FIG. 1. Other embodiments of the video decoder 118 could be used in the video transmission system 100, and the video decoder 118 shown in FIG. 4 could be used in any other suitable device, structure, or system without departing from the scope of this disclosure.

In general, the video decoder 118 performs the inverse of the functions that were performed by the video encoder 110 of FIG. 2, thereby decoding the video frames 214 encoded by the encoder 110. In the illustrated example, the video decoder 118 includes a demultiplexer 402. The demultiplexer 402 receives the bitstream 220 produced by the video encoder 110. The demultiplexer 402 demultiplexes the bitstream 220 and separates the encoded video bands, the encoded motion vectors produced by MC-DCT coding, and the encoded motion vectors produced by MCTF.

The encoded video bands are provided to an EZBC decoder 404. The EZBC decoder 404 decodes the video bands that were encoded by the EZBC coder 208. For example, the EZBC decoder 404 performs an inverse of the encoding technique used by the EZBC coder 208 to restore the video bands. As a particular example, the encoded video bands could represent compressed high-pass frames and low-pass frames, and the EZBC decoder 404 may uncompress the high-pass and low-pass frames. Similarly, the motion vectors are provided to two motion vector decoders 406a-406b. The motion vector decoders 406 decode and restore the motion vectors by performing an inverse of the encoding technique used by the motion vector encoders 210. The motion vector decoders 406 may represent any suitable decoder that uses any suitable decoding technique, such as a texture or entropy based decoding technique.

The restored video bands 416a-416n and motion vectors are provided to a DCT decoder 407 and to a plurality of inverse motion compensated temporal filters (inverse MCTFs) 408a-408m. The DCT decoder 407 processes and restores the lowest resolution video band 416a by performing inverse DCT coding. The inverse MCTFs 408 process and restore the remaining video bands 416b-416n. For example, the inverse MCTFs 408 may perform temporal synthesis to reverse the effect of the temporal filtering done by the MCTFs 204. The inverse MCTFs 408 may also perform motion compensation to reintroduce motion into the video bands 416. In particular, the inverse MCTFs 408 may process the high-pass and low-pass frames generated by the MCTFs 204 to restore the video bands 416. In other embodiments, the inverse MCTFs 408 may be replaced by inverse UMCTFs.

The restored video bands 416 are then provided to an inverse wavelet transformer 410. The inverse wavelet transformer 410 performs a transformation function to transform the video bands 416 from the wavelet domain back into the spatial domain. Depending on, for example, the amount of information received in the bitstream 220 and the processing power of the video decoder 118, the inverse wavelet transformer 410 may produce one or more different sets of restored video signals 414a-414c. In some embodiments, the restored video signals 414a-414c have different resolutions. For example, the first restored video signal 414a may have a low resolution, the second restored video signal 414b may have a medium resolution, and the third restored video signal 414c may have a high resolution. In this way, different types of streaming video receivers 104 with different processing capabilities or different bandwidth access may be used in the system 100.

The restored video signals 414 are provided to a low band shifter 412. As described above, the video encoder 110 processes the input video frames 214 using one or more overcomplete wavelet expansions 218. The video decoder 118 uses previously restored video frames in the restored video signals 414 to generate the same or approximately the same overcomplete wavelet expansions 418. The overcomplete wavelet expansions 418 are then provided to the inverse MCTFs 408 for use in decoding the video bands 416.

Although FIGS. 2-4 illustrate an example video encoder, overcomplete wavelet expansion, and video decoder, various changes may be made to FIGS. 2-4. For example, the video encoder 110 could include any number of MCTFs 204, and the video decoder 118 could include any number of inverse MCTFs 408. Also, any other overcomplete wavelet expansion could be used by the video encoder 110 and video decoder 118. In addition, the inverse wavelet transformer 410 in the video decoder 118 could produce restored video signals 414 having any number of resolutions. As a particular example, the video decoder 118 could produce n sets of restored video signals 414, where n represents the number of video bands 416.

FIGS. 5A and 5B illustrate example encodings of video information according to one embodiment of this disclosure. In particular, FIG. 5A illustrates an example encoding when the video encoder 110 supports both spatial and quality scalability, and FIG. 5B illustrates an example encoding when the video encoder 110 supports spatial, temporal, and quality scalability.

In FIG. 5A, a group of video frames 500 is being encoded by the video encoder 110. The group of frames 500 has been decomposed into two decomposition levels. The video encoder 110 identifies the band with the lowest resolution, which in the illustrated embodiment is the band labeled A₂^{o}. This band represents the base layer of the group of video frames 500. The MC-DCT coder 203 in the video encoder 110 then encodes the A₂^{o} band using MC-DCT based encoding, such as MPEG-2, MPEG-4, or ITU-T H.26L.

The remaining bands in the group 500 (Aⱼⁱ, i=1,2,3, j=1,2) represent the enhancement layer of the group of video frames 500. The MCTFs 204 in the video encoder 110 encode these bands using inband MCTF or UMCTF in the overcomplete wavelet domain.

The base layer encoded using MC-DCT may not provide enough motion vectors for temporal filtering, and these motion vectors may be needed by the temporal filters in the MCTFs 204. Because the MC-DCT coder 203 may provide motion vectors for the first decomposition level only, additional motion vectors may be needed if the enhancement layer includes multiple decomposition levels (which is true in FIG. 5A). To generate the additional motion vectors, 3D inband MCTF or UMCTF is applied both to the base layer and to the other bands. In other words, the base layer may be processed by the MCTFs 204 to generate the motion vectors for the additional decomposition levels. Although FIG. 2 illustrates the video band 216a being provided only to the MC-DCT coder 203, the same video band 216a could also be provided to an MCTF 204. Similarly, although FIG. 4 illustrates the video band 416a being provided only to the MC-DCT decoder 407, the same video band 416a could also be provided to an inverse MCTF 408.

In FIG. 5B, another group of video frames 550 is being encoded by the video encoder 110. The video encoder 110 identifies the band with the lowest resolution, which in the illustrated embodiment is the band labeled A₂^{o}. This band represents the base layer of the group of video frames 550. The MC-DCT coder 203 in the video encoder 110 then encodes the A₂^{o} band in every other frame using MC-DCT based encoding.

The remaining bands in the group 550 (Aⱼⁱ, i=1,2,3, j=1,2) and the skipped A₂^{o} bands represent the enhancement layer of the group of video frames 500. The MCTFs 204 in the video encoder 110 encode these bands using 3D inband MCTF or UMCTF in the overcomplete wavelet domain. In this embodiment, the enhancement layer includes multiple decomposition levels, and motion vectors for the enhancement layer are generated during the 3D inband MCTF or UMCTF because the A₂^{o} bands are encoded as part of the enhancement layer.

Although FIGS. 5A and 5B illustrate example encodings of video information, various changes may be made to FIGS. 5A and 5B. For example, any number of frames could be included in the groups 500, 550. Also, the frames could be decomposed into any number of decomposition levels.

FIG. 6 illustrates an example method 600 for encoding video information in an overcomplete wavelet domain according to one embodiment of this disclosure. The method 600 is described with respect to the video encoder 110 of FIG. 2 operating in the system 100 of FIG. 1. The method 600 may be used by any other suitable encoder and in any other suitable system.

The video encoder 110 receives a video input signal at step 602. This may include, for example, the video encoder 110 receiving multiple frames of video data from a video frame source 108.

The video encoder 110 divides each video frame into bands at step 604. This may include, for example, the wavelet transformer 202 processing the video frames and breaking the frames into n different bands 216. The wavelet transformer 202 could decompose the frames into one or more decomposition levels.

The video encoder 110 generates one or more overcomplete wavelet expansions of the video frames at step 606. This may include, for example, the low band shifter 206 receiving the video frames, identifying the lower band of the video frames, shifting the lower band by different amounts, and augmenting the lower band together to generate the overcomplete wavelet expansions.

The video encoder 110 compresses the base layer of the video frames using MC-DCT at step 608. This may include, for example, the MC-DCT coder 203 encoding the band 216 having the lowest resolution in every frame. This may also include the MC-DCT coder 203 encoding the band 216 having the lowest resolution in a subset of the frames, such as in every other frame.

The video encoder 110 compresses the enhancement layer of the video frames using 3D inband MCTF or UMCTF at step 610. This may include, for example, the MCTFs 204 receiving the video bands 216, estimating the motion in the bands, and generating motion vectors. This may also include the MCTFs 204 using the overcomplete wavelet expansion generated at step 604 to encode the enhancement layer.

The video encoder 110 encodes the filtered video bands at step 612. This may include the EZBC coder 208 receiving the filtered video bands 216 from the MCTFs 204 and compressing the filtered bands 216. The video encoder 110 encodes the motion vectors at step 614. This may include, for example, the motion vector encoder 210 receiving the motion vectors generated by the MCTFs 204 and compressing the motion vectors. The video encoder 110 generates an output bitstream at step 616. This may include, for example, the multiplexer 212 receiving the compressed video bands 216 and compressed motion vectors and multiplexing them into a bitstream 220. At this point, the video encoder 110 may take any suitable action, such as communicating the bitstream to a buffer for transmission over the data network 106.

Although FIG. 6 illustrates one example of a method 600 for encoding video information in an overcomplete wavelet domain, various changes may be made to FIG. 6. For example, various steps shown in FIG. 6 could be executed in parallel in the video encoder 110, such as steps 604 and 606. Also, the video encoder 110 could generate an overcomplete wavelet expansion multiple times during the encoding process, such as one for each group of frames processed by the encoder 110.

FIG. 7 illustrates an example method 700 for decoding video information in an overcomplete wavelet domain according to one embodiment of this disclosure. The method 700 is described with respect to the video decoder 118 of FIG. 4 operating in the system 100 of FIG. 1. The method 700 may be used by any other suitable decoder and in any other suitable system.

The video decoder 118 receives a video bitstream at step 702. This may include, for example, the video decoder 110 receiving the bitstream over the data network 106.

The video decoder 118 separates encoded video bands and encoded motion vectors in the bitstream at step 704. This may include, for example, the multiplexer 402 separating the video bands and the motion vectors and sending them to different components in the video decoder 118.

The video decoder 118 decodes the video bands at step 706. This may include, for example, the EZBC decoder 404 perform inverse operations on the video bands to reverse the encoding performed by the EZBC coder 208. The video decoder 118 decodes the motion vectors at step 708. This may include, for example, the motion vector decoder 406 perform inverse operations on the motion vectors to reverse the encoding performed by the motion vector encoder 210.

The video decoder 118 decompresses the base layer of the video frames using MC-DCT at step 710. This may include, for example, the MC-DCT decoder 407 decoding the band 416 having the lowest resolution in every frame. This may also include the MC-DCT decoder 407 decoding the band 416 having the lowest resolution in a subset of the frames, such as in every other frame.

The video decoder 118 decompresses the enhancement layer of the video frame (if possible) using inverse 3D inband MCTF or UMCTF at step 712. This may include, for example, the inverse MCTFs 408 receiving the bands 416 and compensating for motion in the original video frames 214 using the motion vectors.

The video decoder 118 transforms the restored video bands 416 at step 714. This may include, for example, the inverse wavelet transformer 410 transforming the video bands 416 from the wavelet domain to the spatial domain. This may also include the inverse wavelet transformer 410 generating one or more sets of restored signals 414, where different sets of restored signals 414 have different resolutions.

The video decoder 118 generates one or more overcomplete wavelet expansions of the restored video frames in the restored signal 414 at step 716. This may include, for example, the low band shifter 412 receiving the video frames, identifying the lower band of the video frames, shifting the lower band by different amounts, and augmenting the lower bands. The overcomplete wavelet expansion is then provided to the inverse MCTFs 408 for use in decoding additional video information.

Although FIG. 7 illustrates one example of a method 700 for decoding video information in an overcomplete wavelet domain, various changes may be made to FIG. 7. For example, various steps shown in FIG. 7 could be executed in parallel in the video decoder 118, such as steps 706 and 708. Also, the video decoder 118 could generate an overcomplete wavelet expansion multiple times during the decoding process, such as one for each group of frames decoded by the decoder 118.

It may be advantageous to set forth definitions of certain words and phrases that have been used in this patent document. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document. Those of ordinary skill in the art should understand that in many, if not most instances, such definitions apply to prior as well as future uses of such defined words and phrases.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

1. A video encoder (110) for compressing an input stream (214) of video frames, comprising:
base layer circuitry comprising a motion compensated discrete cosine transform (MC-DCT) coder (203) operable to compress base layer video data associated with the input stream (214) to generate compressed base layer video data suitable for transmission over a network (106); and
enhancement layer circuitry operable to compress enhancement layer video data associated with the input stream (214) to generate compressed enhancement layer video data suitable for transmission over the network (106), the enhancement layer circuitry comprising a plurality of motion compensated temporal filters (204) operable to process the enhancement layer video data in an overcomplete wavelet domain.

2. The video encoder (110) of claim 1, further comprising:
a wavelet transformer (202) operable to transform each of the video frames into a plurality of video bands;
a low band shifter (206) operable to generate one or more overcomplete wavelet expansions, the motion compensated temporal filters (204) operable to use the one or more overcomplete wavelet expansions when filtering the video frames, the MC-DCT coder (203) and at least one of the motion compensated temporal filters (204) generating one or more motion vectors;
a first encoder (208) operable to encode the video bands after filtering by the motion compensated temporal filters (204);
a plurality of second encoders (210) operable to encode the motion vectors; and
a multiplexer (212) operable to multiplex the encoded video bands and the encoded motion vectors onto an output bitstream (220).

3. The video encoder (110) of claim 2, wherein:
the MC-DCT coder (203) comprises one of an MPEG-2 encoder, an MPEG-4 encoder, and an H.26L encoder;
the motion compensated temporal filters (204) comprise unconstrained motion compensated temporal filters; and
the second encoders (210) comprise entropy encoders.

4. A video decoder (118) for decompressing a video bitstream (220), comprising:
base layer circuitry comprising a motion compensated discrete cosine transform (MC-DCT) decoder (407) operable to decompress base layer video data contained in the bitstream (220) to generate decompressed base layer video data; and
enhancement layer circuitry operable to decompress enhancement layer video data contained in the bitstream (220) to generate decompressed enhancement layer video data, the enhancement layer circuitry comprising a plurality of inverse motion compensated temporal filters (408) operable to process the enhancement layer video data in an overcomplete wavelet domain.

5. The video decoder (118) of claim 4, further comprising:
a demultiplexer (402) operable to demultiplex encoded video bands and encoded motion vectors from the bitstream (220);
a first decoder (406a) operable to decode a first set of the motion vectors, the MC-DCT decoder (407) operable to process the video band forming the base layer using the first set of the decoded motion vectors;
a second decoder (406b) operable to decode a second set of the motion vectors, the inverse motion compensated temporal filters (408) operable to process the video bands forming the enhancement layer using the second set of decoded motion vectors;
an inverse wavelet transformer (410) operable to transform the processed video bands into a plurality video frames; and
a low band shifter (412) operable to generate one or more overcomplete wavelet expansions, the inverse motion compensated temporal filters (408) operable to use the one or more overcomplete wavelet expansions when processing the video frames.

6. The video decoder (118) of claim 5, wherein:
the MC-DCT decoder (407) comprises one of an MPEG-2 decoder, an MPEG-4 decoder, and an H.26L decoder;
the inverse motion compensated temporal filters (408) comprise inverse unconstrained motion compensated temporal filters; and
the first and second decoders (406) comprise entropy decoders.

7. A method (600) for compressing an input stream (214) of video frames, comprising:
compressing base layer video data associated with the input stream (214) using motion compensated discrete cosine transform (MC-DCT) coding to generate compressed base layer video data suitable for transmission over a network (106); and
compressing enhancement layer video data associated with the input stream (214) using motion compensated temporal filtering in an overcomplete wavelet domain to generate compressed enhancement layer video data suitable for over the network (106).

8. The method (600) of claim 7, wherein compressing the base layer video data and the enhancement layer video data comprises generating one or more motion vectors, and further comprising:
transforming each of the video frames into a plurality of video bands;
generating one or more overcomplete wavelet expansions, wherein compressing the enhancement layer video data comprises compressing the enhancement layer video data using the one or more overcomplete wavelet expansions;
encoding the video bands after the motion compensated temporal filtering;
encoding the motion vectors; and
multiplexing the encoded video bands and the encoded motion vectors onto an output bitstream.

9. A method (700) for decompressing a video bitstream (220), comprising:
decompressing base layer video data contained in the bitstream (220) using motion compensated discrete cosine transform (MC-DCT) decoding to generate decompressed base layer video data; and
decompressing enhancement layer video data contained in the bitstream (220) using inverse motion compensated temporal filtering in an overcomplete wavelet domain to generate decompressed enhancement layer video data.

10. The method (700) of claim 9, further comprising:
demultiplexing encoded video bands and encoded motion vectors from the bitstream (220);
decoding a first set of the motion vectors and a second set of the motion vectors, wherein decompressing the base layer video data comprises decompressing the base layer video data using the first set of the decoded motion vectors and decompressing the enhancement layer video data comprises decompressing the enhancement layer video data using the second set of decoded motion vectors;
transforming restored video bands into a plurality video frames; and
generating one or more overcomplete wavelet expansions, wherein decompressing the enhancement layer video data comprises decompressing the enhancement layer video data using the one or more overcomplete wavelet expansions.

11. A video transmitter (102), comprising:
a video frame source (108) operable to provide a stream of video frames;
a video encoder (110) operable to compress the video frames, the video encoder (110) comprising:
base layer circuitry comprising a motion compensated discrete cosine transform (MC-DCT) coder (203) operable to compress base layer video data associated with the stream to generate compressed base layer video data suitable for transmission over a network (106); and
enhancement layer circuitry operable to compress enhancement layer video data associated with the stream to generate compressed enhancement layer video data suitable for transmission over the network (106), the enhancement layer circuitry comprising a plurality of motion compensated temporal filters (204) operable to process the enhancement layer video data in an overcomplete wavelet domain; and
a buffer (112) operable to receive and store the compressed video frames for transmission over the network (106).

12. The video transmitter (102) of claim 11, further comprising:
a wavelet transformer (202) operable to transform each of the video frames into a plurality of video bands;
a low band shifter (206) operable to generate one or more overcomplete wavelet expansions, the motion compensated temporal filters (204) operable to use the one or more overcomplete wavelet expansions when filtering the video frames, the MC-DCT coder (203) and at least one of the motion compensated temporal filters (204) generating one or more motion vectors;
a first encoder (208) operable to encode the video bands after filtering by the motion compensated temporal filters (204);
a plurality of second encoders (210) operable to encode the motion vectors; and
a multiplexer (212) operable to multiplex the encoded video bands and the encoded motion vectors onto an output bitstream (220).

13. A video receiver (104), comprising:
a buffer (116) operable to receive and store a video bitstream;
a video decoder (118) operable to decompress the video bitstream and generate video frames, the video decoder (118) comprising:
base layer circuitry comprising a motion compensated discrete cosine transform (MC-DCT) decoder (407) operable to decompress base layer video data contained in the bitstream to generate decompressed base layer video data; and
enhancement layer circuitry operable to decompress enhancement layer video data contained in the bitstream to generate decompressed enhancement layer video data, the enhancement layer circuitry comprising a plurality of inverse motion compensated temporal filters (408) operable to process the enhancement layer video data in an overcomplete wavelet domain; and
a video display (120) operable to present the video frames.

14. The video receiver of claim 13, further comprising:
a demultiplexer (402) operable to demultiplex encoded video bands and encoded motion vectors from the bitstream;
a first decoder (406a) operable to decode a first set of the motion vectors, the MC-DCT decoder (407) operable to process the video band forming the base layer using the first set of the decoded motion vectors;
a second decoder (406b) operable to decode a second set of the motion vectors, the inverse motion compensated temporal filters (408) operable to process the video bands forming the enhancement layer using the second set of decoded motion vectors;
an inverse wavelet transformer (410) operable to transform the processed video bands into a plurality video frames; and
a low band shifter (412) operable to generate one or more overcomplete wavelet expansions, the inverse motion compensated temporal filters (408) operable to use the one or more overcomplete wavelet expansions when processing the video frames.

15. A computer program embodied on a computer readable medium and operable to be executed by a processor, the computer program comprising computer readable program code for:
compressing base layer video data associated with an input stream (214) of video frames using motion compensated discrete cosine transform (MC-DCT) coding to generate compressed base layer video data suitable for transmission over a network (106); and
compressing enhancement layer video data associated with the input stream (214) using motion compensated temporal filtering in an overcomplete wavelet domain to generate compressed enhancement layer video data suitable for transmission over the network (106).

16. The computer program of claim 15, wherein the computer program further comprises computer readable program code for:
transforming each of the video frames into a plurality of video bands;
generating one or more overcomplete wavelet expansions, wherein compressing the enhancement layer video data comprises compressing the enhancement layer video data using the one or more overcomplete wavelet expansions;
encoding the motion vectors; and
multiplexing the encoded video bands and the encoded motion vectors onto an output bitstream.

17. A computer program embodied on a computer readable medium and operable to be executed by a processor, the computer program comprising computer readable program code for:
decompressing base layer video data contained in a video bitstream (220) using motion compensated discrete cosine transform (MC-DCT) decoding to generate decompressed base layer video data; and
decompressing enhancement layer video data contained in the bitstream (220) using inverse motion compensated temporal filtering in an overcomplete wavelet domain to generate decompressed enhancement layer video data.

18. The computer program of claim 17, wherein the computer program further comprises computer readable program code for:
demultiplexing encoded video bands and encoded motion vectors from the bitstream (220);
decoding a first set of the motion vectors and a second set of the motion vectors, wherein decompressing the base layer video data comprises decompressing the base layer video data using the first set of the decoded motion vectors and decompressing the enhancement layer video data comprises decompressing the enhancement layer video data using the second set of decoded motion vectors;
transforming restored video bands into a plurality video frames; and
generating one or more overcomplete wavelet expansions, wherein decompressing the enhancement layer video data comprises decompressing the enhancement layer video data using the one or more overcomplete wavelet expansions.

19. A transmittable video signal produced by the steps of:
compressing base layer video data associated with an input stream (214) of video frames using motion compensated discrete cosine transform (MC-DCT) coding to generate compressed base layer video data suitable for transmission over a network (106); and
compressing enhancement layer video data associated with the input stream (214) using motion compensated temporal filtering in an overcomplete wavelet domain to generate compressed enhancement layer video data suitable for transmission over the network (106).
